(19) United States
(12) Patent Application Publication
(10) Pub. No.: US 2014/0125535 A1
(43) Pub. Date: May 8, 2014

(54) CAPACITIVELY COUPLED ANTENNA APPARATUS AND METHODS

(71) Applicant: Pulse Finland OY, Kempele (FI)

(72) Inventors: Prasadh Ramachandran, Oulu (FI); Petteri Annamaa, Oulunsalo (FI)

(21) Appl. No.: 13/794,343

(22) Filed: Mar. 11, 2013

Related U.S. Application Data
(60) Provisional application No. 61/723,243, filed on Nov. 6, 2012.

(51) Int. Cl. H01Q 9/30

(52) U.S. Cl. CPC H01Q 9/30
USPC 343/745; 343/749

(57) ABSTRACT

Capacitively coupled antenna apparatus and methods of operating and adaptively tuning the same. In one embodiment, the insertion loss component in “beside the hand/head” use scenarios is significantly reduced or eliminated such that the antenna experiences only absorptive losses (which generally cannot be avoided), and a very small insertion loss by the host device radio frequency tuner. The exemplary antenna apparatus may be configured for multi-band operation, and also has a very small form factor (e.g., 3 mm ground clearance only at the bottom of the PCB, 4 mm height in one implementation), thereby allowing for use in spatially compact host devices such as slim-line smartphones, tablets, and the like. The adaptive antenna arrangement (using capacitive feed) can be tuned such that the tuner is used in free space, and the user's hand/head tunes the antenna to the band of interest while in use.

This application claims priority to co-owned and co-pending U.S. Provisional Patent Application Ser. No. 61/723,243 filed Nov. 6, 2012 of the same title, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technology Field

The present disclosure relates generally to antenna apparatus for use in electronic devices such as wireless radio devices, and more particularly in one exemplary aspect to a capacitively coupled antenna apparatus, and methods of, inter alfa, tuning and utilizing the same.

2. Description of Related Technology

Current trends in mobile wireless devices demand generally compact (e.g., thin) form factor devices with a large display. Along with these demands are operator requirements on FS (freespace) BHR/L (Beside Head Right/Left) and BHHR/L (Beside head hand right/Left) performance. Radio frequency tuners are currently being used to compensate for the antenna mismatch in beside head/hand scenarios. Typical prior art antennas are “tuned” for freespace, and the antenna thus detunes in the presence of the user's hand/head (i.e., a head/hand is a capacitive loading factor which causes detuning and mismatch of the antenna). An impedance tuner is then able to match the antenna back to a sufficient matching level. Thus, in the end, the total efficiency of the antenna in the hand/head use scenarios is equal to the total efficiency in freespace minus absorptive losses by the user's hand/head, minus the insertion loss of the tuner, and minus the mismatch loss.

The typical prior art tuner is able to remove the mismatch loss by improving the matching to the source impedance (typically 50 ohm). However, in the detuned case when the mismatch is large, the tuner also introduces a large insertion loss. Thus, the loss components include absorptive loss plus a significant insertion loss, which is not optimal.

Accordingly, there is a salient need for, inter alia, an improved antenna solution that can provide the required electrical and other performance attributes, yet with reduced insertion loss in such operational scenarios as those described above.

### SUMMARY

The present invention satisfies the foregoing needs by providing, inter alia, improved antenna apparatus and methods useful in, e.g., mobile wireless devices.

In a first aspect of the invention, an antenna apparatus is disclosed. In one embodiment, the apparatus includes: a ground plane; high and low band radiator elements; and a capacitance.

In a second aspect, a method of manufacturing an antenna element is disclosed.

In a third aspect of the invention, a method of tuning an antenna is disclosed. In one embodiment, the adaptive antenna arrangement (using capacitive feed) can be tuned such that the tuner is used in free space, and the user's hand/head tunes the antenna to the band of interest while in use.

In a fourth aspect of the invention, a method of reducing the insertion loss of an antenna is disclosed.

In a fifth aspect of the invention, a method of providing a high isolation between different ports of an antenna is disclosed.

In a sixth aspect, a method of operating an antenna is disclosed. In one embodiment, the user's hand/head adaptively tunes the antenna to the band of interest while in use, the device having been tuned in freespace conditions through use of an RF tuning apparatus.

Further features of the present disclosure, its nature and various advantages will be more apparent from the accompanying drawings and the following detailed description.

### BRIEF DESCRIPTION OF THE DRAWINGS

The features, objectives, and advantages of the disclosure will become more apparent from the detailed description set forth below when taken in conjunction with the drawings, wherein:

FIGS. 1A and 1B are front and rear partial perspective views of an exemplary embodiment of a capacitively coupled antenna element configured according to the disclosure.

FIG. 2 is a graph of return loss (dB) versus frequency (without tuner) of the exemplary antenna of FIGS. 1A and 1B.

FIG. 3 is a graph of antenna isolation (dB) versus frequency from the lower antenna frequency band (LB) to the higher band (HB), for the exemplary antenna of FIGS. 1A and 1B.

FIG. 4 is a graph of measured total efficiency as a function of frequency for the antenna of FIGS. 1A and 1B for various host device positions.

FIG. 4a is a graph of radiation and total efficiency for the antenna of FIGS. 1A and 1B for various host device positions.

FIG. 5 is a block diagram of an exemplary closed loop adaptive tuning arrangement for the capacitively coupled antenna of FIGS. 1A-1B, according to one embodiment.

All Figures disclosed herein are © Copyright 2012-2013 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” and “antenna system,” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “portable device”, “mobile device”, “client device”, “portable wireless device”, and “host device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” and “radiating element” refer without limitation to an element that can function as part of a system that receives and/or transmits radio-frequency electromagnetic radiation; e.g., an antenna.

The terms “RF feed,” “feed” and “feed conductor” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down”, “left”, “right”, “back”, “front”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, NFC/RFID, CDPD, satellite systems such as GPS, millimeter wave or microwave systems, optical, acoustic, and infrared (i.e., IrDA).

### Detailed Description of Exemplary Embodiments

Detailed descriptions of the various embodiments and variants of the apparatus and methods of the disclosure are now provided. While primarily discussed in the context of user mobile devices such as smartphones or tablet computers (or so-called “phablets”), the various apparatus and methodologies discussed herein are not so limited. In fact, the apparatus and methodologies of the disclosure may be useful in any number of antennas and/or host devices, whether associated with mobile or fixed devices.

### Exemplary Antenna Element Apparatus and Methods

The present disclosure provides, in one salient aspect, an improved antenna apparatus and methods of operating and tuning the same. Specifically, in one embodiment, the insertion loss component in “beside the hand/head” use scenarios is significantly reduced or eliminated such that the antenna experiences only absorptive losses (which generally cannot be avoided), and a very small insertion loss by the host device radio frequency tuner. The exemplary antenna apparatus also has a very small form factor (e.g., 3 mm ground clearance only at the bottom of the PCB, 4 mm height in one implementation), thereby allowing for use in spatially compact host devices such as slim-line smartphones, tablets, and the like.

In one variant, a capacitively coupled antenna arrangement is used. The antenna is constructed such that in a “freespace” condition (i.e., not proximate the user), the antenna is poorly matched (considering an exemplary 50 ohm environment). But in hand/head use scenarios (which are the scenarios which users would actually be using the device), the loading by the user's hand improves the antenna's return loss (i.e., matching level) significantly, thus using the loading capacitance of the hand/head to improve the antenna matching. This approach advantageously results in the tuner having minimal insertion loss, as the matching is already very good by virtue of the foregoing loading. Alternatively, the tuner may even be bypassed in scenarios where the matching is good/suitable, thus further reducing the insertion loss.

In another embodiment, the use (or non-use of the tuner) is adaptively or dynamically varied, depending on detected operating conditions (such as by way of computerized logic resident on the host device). In this manner, the tuner (and its associated insertion loss) is only used when absolutely necessary.

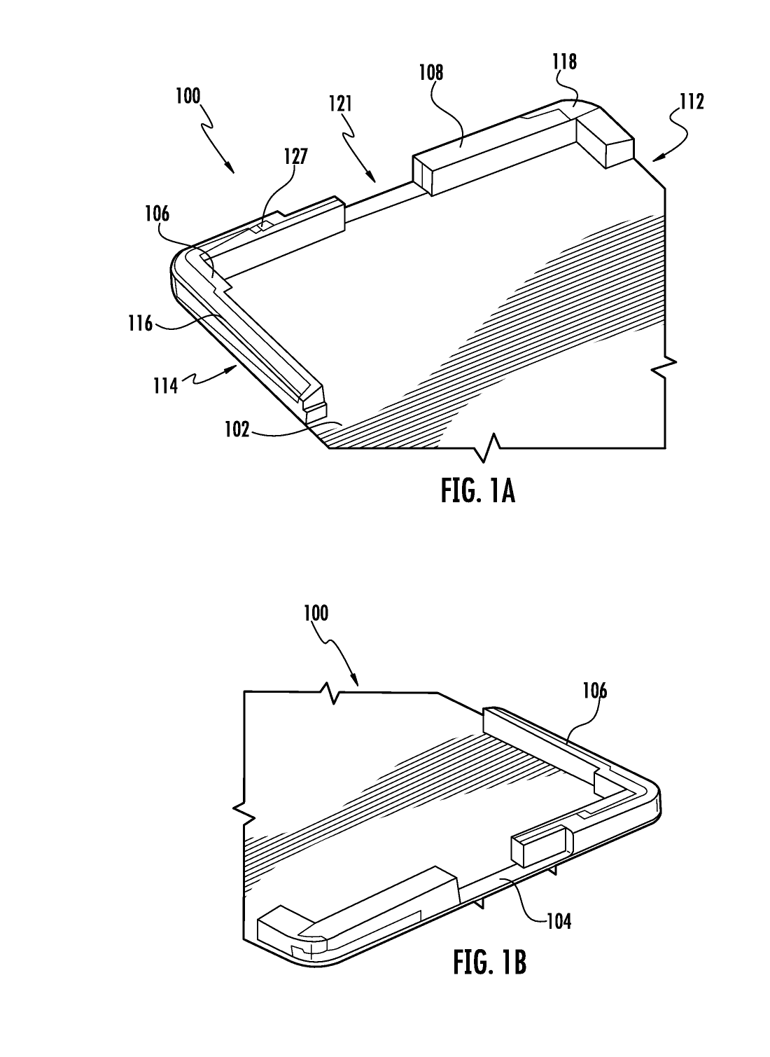

Referring now to FIGS. 1A-1E, an exemplary embodiment of the antenna element 100 configured in accordance with the disclosure is shown and described.

As shown in FIG. 1A, the exemplary antenna apparatus 100 comprises a substrate (e.g., PCB) 102, having at least a portion thereof including a conductive ground plane 104. Peripheral non-conductive elements 106, 108 are disposed around the periphery of the substrate (in this embodiment, so as to substantially conform to the outer shape of the host device such as a smartphone), although it will be recognized that this is not a requirement, and other form factors/component dispositions may be used consistent with the disclosure.

The conductive traces 110 forming the various branches of the radiating elements 116, 118 (e.g., lower band radiator 116 and higher band radiator 118 in the exemplary embodiment) are disposed on the peripheral non-conductive elements in the desired patterns in order to effectuate radiation within the low and high bands.

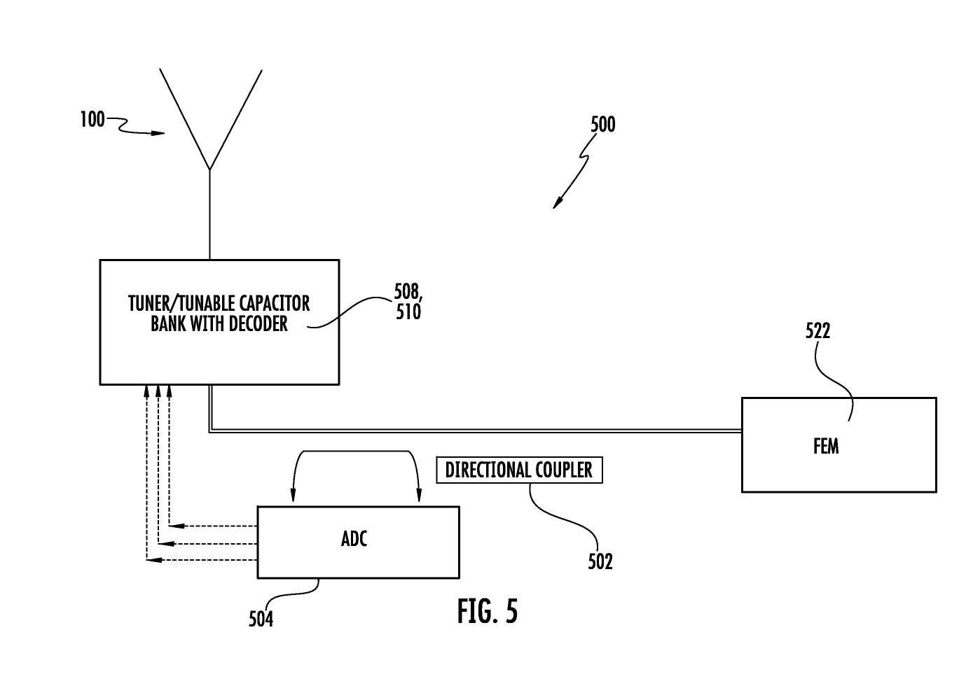

FIG. 1A also illustrates a place 121 for a microUSB or other such connector (not shown). This connector is used with, inter alia, the tuner and procedure of FIG. 5 herein; i.e., the tuner is used in free space and the hand/head tunes the capacitively fed antenna in the band of interest. In an alternative embodiment, a separate antenna radiating element (e.g., for 2.3-2.7 GHz band) can be disposed in this region 121 as well.

The antenna element of FIG. 1A may also utilize a “lumped” capacitance 127, or alternatively a tunable component, such as e.g., a MEMS capacitor bank (high Q), or any other type of tunable/switchable capacitor element, such as an interdigital capacitor.

Separate high-band (HB) and low-band (LB) feeds, 112, 114 are utilized in the apparatus 100 of FIGS. 1A-1B, as illustrated. As discussed in greater detail subsequently herein, this approach affords certain advantages with respect to, inter alia, control of the LB and HB emissions and characteristics, as well as insertion loss of the antenna 100.

In an alternative embodiment, a separate antenna element (not shown) for e.g., a 2.3-2.7 GHz band is placed generally at the designate location 121. In some cases, it may be beneficial to have a separate radiator for certain prescribed bands (e.g., 2.3-2.7 GHz), and hence the present disclosure contemplates such separate antenna element is such cases.

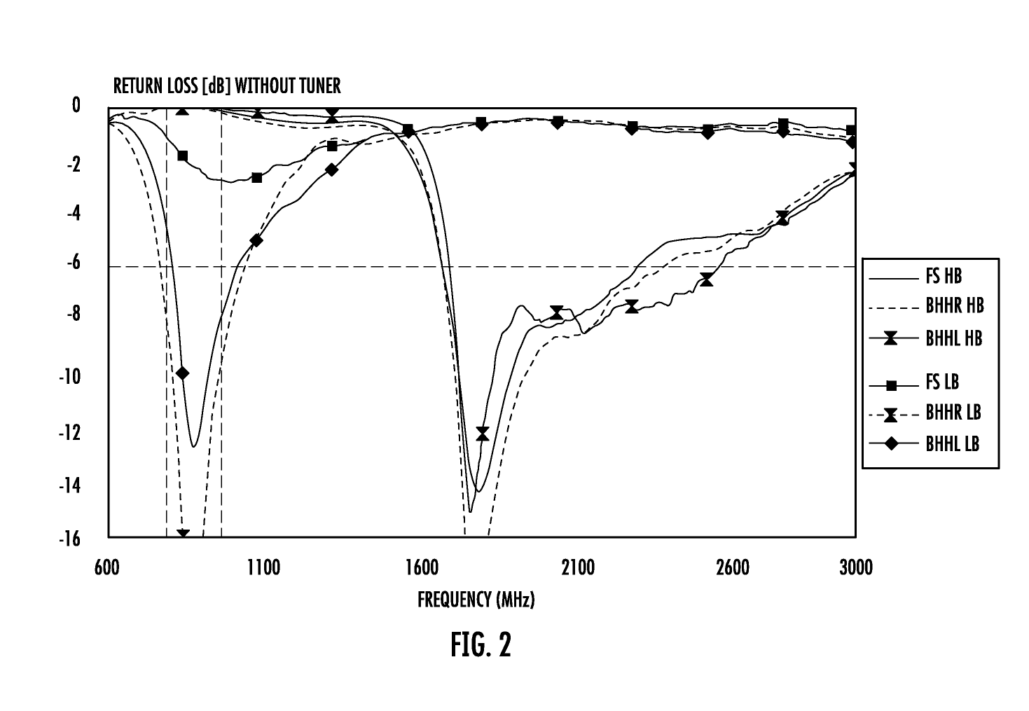

Further, the capacitively coupled antenna apparatus 100 of FIG. 1A advantageously provides the freedom to locate the antenna impedance within a “Smith chart” (i.e., characteristic impedance or Z₀, that is the square root of the inductance/meter divided by the square root of the capacitance per meter of the conductive pathway, as is well known to those of ordinary skill in the radio frequency arts), such that it offers a desirable impedance region for the impedance tuner to operate, with reasonable insertion loss in the aforementioned freespace scenario. In freespace, the antenna has very high radiation efficiency, and thus it can accommodate for some drop in total efficiency due to slightly higher insertion loss by the tuner, while also simultaneously improving the matching. This is most clearly illustrated in FIGS. 2-4 herein.

Specifically, FIG. 2 is a graph of return loss (dB) versus frequency (without tuner) of the exemplary antenna of FIGS. 1A and 1B. As illustrated in the Figure, the matching achieved is very good in the BHHR/L (beside head—hand R or L) scenario, thus avoiding the need for tuner in this scenario. In FS (freespace) the matching can be improved by using the tuner.

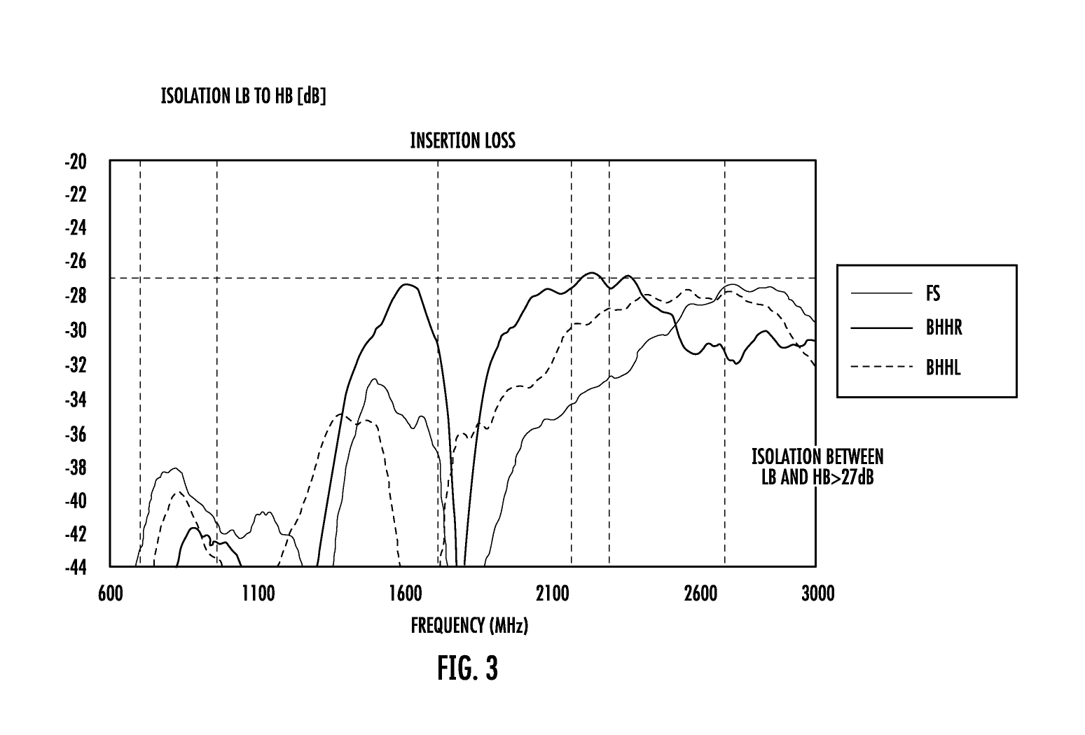

FIG. 3 is a graph of antenna isolation (dB) versus frequency from the lower antenna frequency band (LB) to the higher band (HB), for the exemplary antenna of FIGS. 1A and 1B. Note that in the exemplary embodiment, a high isolation value between the lower band (LB) and higher band (HB) of >27 dB is advantageously achieved.

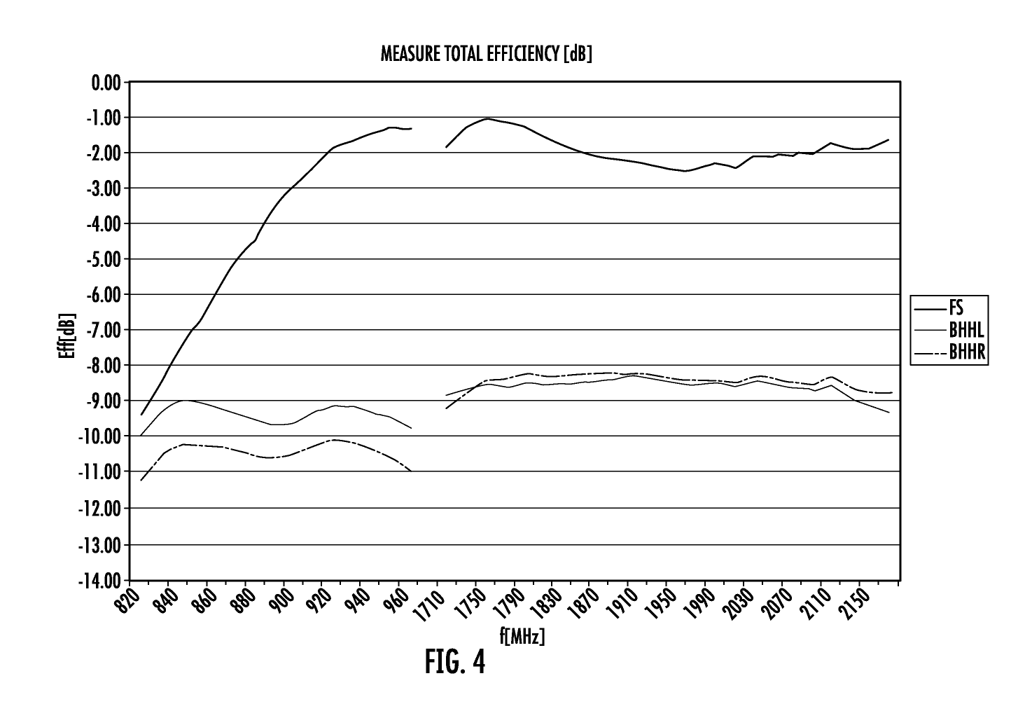

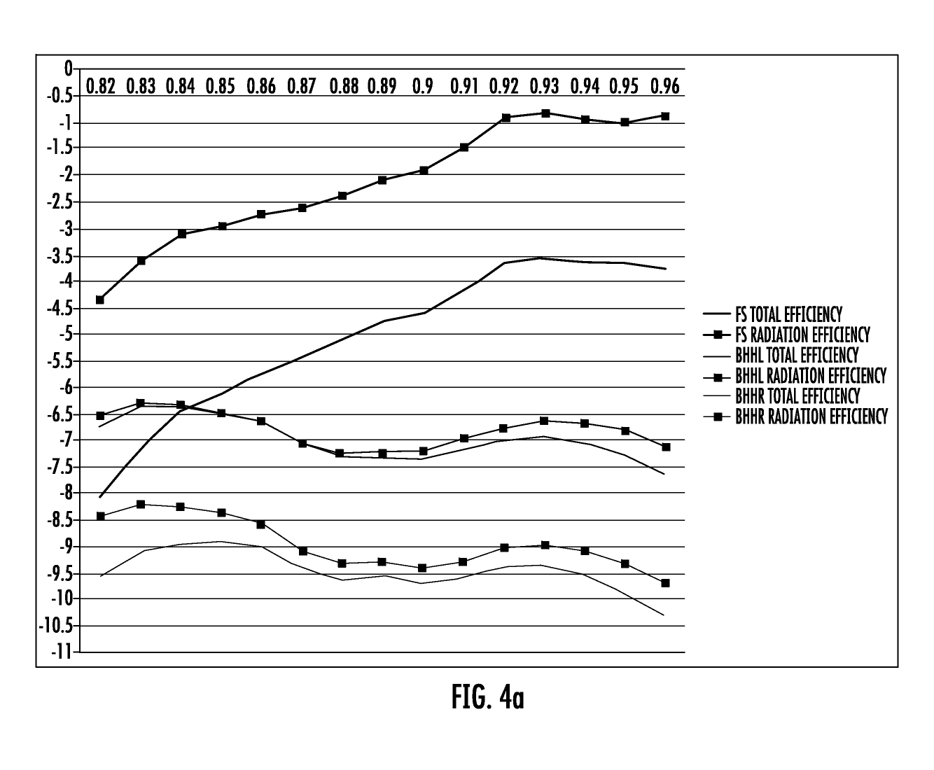

FIG. 4 is a graph of measured total efficiency for the antenna of FIGS. 1A and 1B for various positions. As can be seen in FIG. 4, the potential for total efficiency is very good in the FS (freespace) condition, and the efficiency drops significantly in the other operating conditions mainly due to poor matching. In FS, the exemplary antenna is mismatched; thus, although the radiation efficiency is good, the total efficiency is less than desired (see also FIG. 4a showing radiation and total efficiencies for various configurations). An impedance tuner is used in the exemplary implementation to improve the matching of the antenna. In the BHHR and BHHL cases, the user's hand improves the matching of the antenna, as the hand acts as a capacitive load. Thus, the antenna matching improves significantly (as shown), and the tuner sees a very good match at both ends (i.e., the antenna end and the front end module or FEM end). Accordingly, a good total efficiency value is also achieved in BHHR/L cases.

Alternatively, through use of a bypass switch or similar mechanism in the tuner, the tuner can be completely bypassed for BHHR/L scenarios when the matching of the antenna is very good. Thus, in terms of the total efficiency, there exist “absorptive losses” by the hand and head, and no mismatch loss. For FS, there is a margin of acceptable radiation efficiency, and hence some additional insertion loss by the tuner (needed to improve the matching) is also acceptable.

### Dual Feed Embodiment

The aforementioned operator requirements on FS (freespace) BHR/L (Beside Head Right/Left) and BHHR/L (Beside head hand right/Left) dictate that in order to optimize a given antenna for the different operating scenarios, it is beneficial to separate the feeds to the HB and the LB. This creates a requirement for a diplexer or similar apparatus to feed to a single feed “engine”, where the signals are again separated into LB and HB by the diplexer internally. This architecture creates an insertion loss within the RF chain on the order of ≈0.5 dB (in the case of current wireless technologies individually), and an insertion loss of ≈0.5 dB+0.5 dB=1 dB (in the case of carrier aggregation, where the LB and HB frequencies are being utilized at the same time). This insertion loss can be eliminated by using a dual-feed front end module without a diplexer. This solution however requires an antenna with high port isolation (>25 dB) to replace the diplexer.

Hence, in another embodiment of the antenna apparatus, a high isolation value between the feed ports is implemented; this high isolation provides the ability to use a dual-feed RF front end module (without diplexer). The high isolation is created in the illustrated embodiment from the usage of the capacitive antenna structure, and by the usage of the tuner (matching circuit) for the low (or high) band. When the foregoing are used, a low pass filter is created (low band) or high pass filter (high band), thus improving the isolation between the bands.

It is further noted that the antenna feeds may be used to provide some of the aforementioned isolation functionality; i.e., LB feed disposed at e.g., the middle of the board, and the HB feed disposed at e.g., an end of the board. A grounded element such as a USB connector (or a third radiator element at e.g., 2.3-2.7 GHz radiator in the place of the USB connector, as described supra) further aids in improving the electromagnetic isolation between the LB and HB radiators.

The low insertion loss in the RF chain leads to better TRP (total radiated power) and TIS (total isotropic sensitivity) performance as well. Additionally, separating the feeds as described supra (i.e., into an LB feed and an HB feed) gives the designer more freedom to optimize the radiator pattern for low absorption loss for each of the HB and LB individually. Specifically, separation of the HB and LB feeds optimize the antenna patterns and performance for FS, BHR/L, BHHR/L scenarios, and reduce the insertion loss in the RF chain, thus giving a better overall system performance.

It will be appreciated from the foregoing that the exemplary embodiments of the antenna apparatus as disclosed herein has several advantages, including without limitation: (i) use of separate HB and LB feeds to optimize the antenna pattern for performance within FS, BHR/L, and BHHR/L use scenarios; (ii) reduction of the insertion loss in the RF chain (conductive pathway), thus giving a better overall system performance; (iii) the antenna apparatus 100 can be located on any side of the device, and tuned to cover the required band(s); (iv) well-known and low cost flex, ceramic, sheet metal, plated plastic parts, LDS (laser direct structuring) or other technologies can be used to create the structure(s) shown; (v) the operating bands are not limited to any specific frequencies, and hence may be applied to a variety of different wireless standards; and (vi) the antenna apparatus 100 can include switching/tuning/impedance tuning elements if desired (not shown), or a combination of all these techniques to improve the matching and to increase the antenna bandwidth.

In terms of manufacturing the antenna embodiments described above, known methods such as LDS, flex substrates, sheet metal, fluid deposition, 2-shot molding, and print deposition can be used to manufacture the various components as applicable, such techniques and structures being readily determined by those of ordinary skill when given the present disclosure.

### Simplified Closed-Loop Tuning

In another aspect of the invention, simplified closed-loop antenna tuning apparatus and methodology are disclosed. Specifically, in one embodiment (shown in FIG. 5 herein), the simplified closed loop adaptive tuning approach of the invention eliminating the use of MCU and complex algorithms for tuning which consume current and increases the cost of the system. It also can advantageously be applied to any wireless system or technology/standard (e.g., GSM, WCDMA, LTE). Moreover, no additional information or algorithm support is needed from the baseband in order to effect the tuning approach.

In the exemplary configuration 500 of FIG. 5, the directional coupler 502 detects the forward and reflected radio frequency power (from the RF front-end module, or FEM 522, and provides an output to the analog-to-digital converter (ADC) 504, and power to the voltage convertor (not shown). This digital value (i.e., from the ADC) and voltage are then fed to the decoder 508, which sets the states of the tuner 510 to a predefined value. It will be appreciated that while the decoder can receive frequency band information as an input from e.g., the baseband processor (not shown), it may be obtained from other sources. The tuner matches the antenna in the freespace (FS) scenario, when the impedance of the antenna is defined. Thus, the tuner in one implementation consults a look-up table or similar mechanism built internally to the device to set the required tuner state (i.e., if 1 tuner state is enough to cover the entire operating band). Alternatively, the decoder can obtain band information (e.g., from the baseband processor) and set the tuner state accordingly, so as to set the tuner to the required band of operation.

When the antenna is in an hand-held and/or beside-the-head operating condition, the antenna improves the matching. Thus, from the measured DC (measured in the illustrated embodiment at the Analog to Digital Converter), a feedback indicating the extent of mismatch is provided. For instance, when S11≈−10 dB, the tuner switches either to a bypass switch, or chooses a predefined state having the least insertion loss, which has been predefined during the antenna design phase.

It will be appreciated that the antenna apparatus disclosed herein (e.g., that of FIGS. 1A and/or 1B, or yet other shapes) may be arranged in a wide variety of shapes and configurations; the foregoing shapes and array configurations are accordingly merely illustrative. Moreover, the various functions and features described herein may readily be applied to other types of antennas by those of ordinary skill given the present disclosure.

It will be recognized that while certain aspects of the disclosure are described in terms of a specific sequence of steps of a method, these descriptions are only illustrative of the broader methods, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claims provided herein.

While the above detailed description has shown, described, and pointed out novel features as applied to various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles of the disclosure.

What is claimed is:

1. A method of tuning an antenna, comprising:
tuning the antenna in a freespace operating condition using a tuner having an insertion loss; and
utilizing the tuned antenna in a capacitively loaded operating condition, the capacitive loading further tuning the antenna without use of the tuner.

2. The method of claim 1, wherein the capactively loaded condition comprises at least a portion of a user's anatomy being in physical contact with or spatially proximate to the antenna.

3. The method of claim 2, wherein the use of the capacitive loading to further tune the antenna without use of the tuner reduces an insertion loss that would otherwise be introduced by the tuner.

4. The method of claim 3, further comprising using the reduced insertion loss to enhance TRP (total radiated power) and TIS (total isotropic sensitivity) performance.

5. The method of claim 3, wherein the tuning the antenna in the freespace operating condition comprises tuning so that that antenna matching or return loss is poor.

6. A mobile device, comprising:
a housing;
a wireless transceiver;
an antenna in signal communication with the transceiver and disposed substantially within or on the housing; and
a tuner in electrical communication with the antenna;
wherein the antenna is tuned using at least the tuner such that low antenna matching exists in a freespace condition, and capacitive loading imparted by a user during use of the mobile device substantially optimizes the antenna matching during such use without use of said tuner.

7. A mobile wireless device capable of operating in at least first and second frequency bands, comprising:
a wireless transceiver;
a front end module in signal communication with the transceiver, the front end module comprising at least first and second signal feed; and
antenna apparatus in signal communication with the module, the antenna apparatus comprising a matching circuit;
wherein the matching circuit is configured to create a low pass filter for the first band, and a high pass filter for the second band, the second band higher in frequency than the first, the low- and high-pass filters providing increased isolation between the ports in low-band and high-band operation, respectively.

8. The device of claim 7, wherein at least the increased isolation obviates the need for a diplexer for the feed ports.

9. The device of claim 7, wherein the antenna comprises an antenna that is capacitively loaded by a user during use, the capacitive loading further increasing the isolation.
